(19) United States
(12) Patent Application Publication
(10) Pub. No.: US 2024/0024764 A1
(43) Pub. Date: Jan. 25, 2024

(54) EXPANSION DEVICE

(71) Applicant: Chicony Electronics Co., Ltd., New Taipei City (TW)

(72) Inventor: Kai-Yu Cheng, New Taipei City (TW)

(73) Assignee: Chicony Electronics Co., Ltd., New Taipei City (TW)

(21) Appl. No.: 17/985,077

(22) Filed: Nov. 10, 2022

(30) Foreign Application Priority Data
Jul. 25, 2022 (TW) 111127745

(51) Int. Cl. A63F 13/24

(52) U.S. Cl. CPC A63F 13/24

(57) ABSTRACT

An expansion device includes a device body, which includes two carrying structures and a first elastic component, and a clamping structure. The two carrying structures are slidably disposed on each other, each carrying structure has a carrying portion and a clamping portion, and the carrying portion carries an electronic device. The first elastic component is connected to the two carrying structures and causes the two carrying structures to slide from a first state to a second state with variation of an elastic potential energy thereof, and the two clamping portions clamp the electronic device between the first state and the second state. The clamping structure includes a clamping component and a second elastic component. The clamping component is movably disposed on the carrying structure. The second elastic component causes the clamping component to move form a first position to a second position with variation of an elastic potential energy thereof.

### CROSS-REFERENCE TO RELATED APPLICATION

This application claims the priority benefit of Taiwan application serial no. 111127745, filed on Jul. 25, 2022. The entirety of the above-mentioned patent application is hereby incorporated by reference herein and made a part of this specification.

### BACKGROUND

### Technical Field

The disclosure relates to an expansion device, and in particular relates to an expansion device that may clamp an electronic device.

### Description of Related Art

With the development of the mobile game and e-sports industry, gaming smartphones and related peripherals have gradually become popular in the consumer market. For example, in order to provide a good operating experience, an expandable gaming handle may be externally connected to a mobile phone as an input interface. The expandable gaming handle is generally designed based on the appearance and the dimension of the corresponding mobile phone, to be well integrated with the mobile phone. However, a high proportion of consumers uses a protective case to cover their mobile phones. Therefore, in order for the mobile phone to be smoothly equipped with the expandable gaming handle, the protective case of the mobile phone must be removed first, which causes inconvenience in using the expandable gaming handle. In addition, the current expandable gaming handle may not be firmly combined with the mobile phone, and the game operating experience of a user is easily diminished due to the looseness of the expandable gaming handle. Furthermore, the connector of the expandable gaming handle is plugged and unplugged from the mobile phone many times for a long time, which may easily cause damage to the connector of the expandable gaming handle and/or the mobile phone.

### SUMMARY

The disclosure provides an expansion device, which may is suitable for electronic devices of different dimensions and may be firmly combined with the electronic device.

The expansion device of the disclosure is suitable for an electronic device and includes a device body and at least one clamping structure. The device body includes two carrying structures and a first elastic component. The two carrying structures are slidably disposed on each other along a first axial direction, each of the carrying structures has a carrying portion and a clamping portion, and the carrying portion is suitable for carrying the electronic device. The first elastic component is connected between the two carrying structures, the two carrying structures are suitable for relative sliding from a first state to a second state with variation of an elastic potential energy of the first elastic component, and the two clamping portions are suitable for clamping the electronic device between the first state and the second state. The clamping structure includes a clamping component and a second elastic component. The clamping component is movably disposed on one of the carrying structures along a second axial direction. The second elastic component is connected between the clamping component and the corresponding carrying structure, the clamping component is suitable for moving from a first position to a second position with variation of an elastic potential energy of the second elastic component, and is suitable for jointly clamping the electronic device with the carrying portion between the first position and the second position.

In an embodiment of the disclosure, a number of the at least one clamping structures is two, and the two clamping structures are respectively disposed on the two carrying structures. In an embodiment of the disclosure, a distance between the two clamping portions in the second state is greater than a distance between the two clamping portions in the first state, and the two carrying structures are suitable for relatively sliding from the first state to the second state by an elastic force of the first elastic component.

In an embodiment of the disclosure, the device body includes a positioning assembly, the positioning assembly is movably disposed on one of the carrying structures, and is suitable for resisting an elastic force of the first elastic component to position another carrying structure between the first state and the second state.

In an embodiment of the disclosure, the positioning assembly includes a push button, at least one positioning component, and a third elastic component, the push button is slidably disposed on the corresponding carrying structure, and the third elastic component is connected to the at least one positioning component. The at least one positioning component is suitable for positioning the another carrying structure by an elastic force of the third elastic component, and the push button is suitable for moving to drive the at least one positioning component to be separated from the another carrying structure.

In an embodiment of the disclosure, the positioning assembly includes a fourth elastic component, the fourth elastic component is connected between the push button and the corresponding carrying structure, and the push button is suitable for being reset by an elastic force of the fourth elastic component.

In an embodiment of the disclosure, the at least one positioning component has a first gear rack portion, the another carrying structure has a second gear rack portion, and the first gear rack portion and the second gear rack portion are suitable for engaging with each other to position the another carrying structure.

In an embodiment of the disclosure, each tooth of the first gear rack portion has a first blocking surface and a first guide inclined surface that are opposite to each other, and each tooth of the second gear rack portion has a second blocking surface and a second guide inclined surface that are opposite to each other, the first blocking surface and the second blocking surface face each other and prevent the another carrying structure from moving to the first state.

In an embodiment of the disclosure, a distance between the clamping component located at the first position and the carrying portion is greater than a distance between the clamping component located at the second position and the carrying portion, and the clamping component is suitable for moving from the first position to the second position by an elastic force of the second elastic component.

In an embodiment of the disclosure, the clamping structure includes at least one pushing assembly. The at least one pushing assembly is movably disposed on the corresponding carrying structure and is suitable for resisting an elastic force of the second elastic component to push the clamping component from the first position to the second position.

In an embodiment of the disclosure, the pushing assembly includes two push rods. The two push rods are pivotally connected to each other and are suitable for relatively expanding to respectively push against the clamping component and the corresponding carrying portion, so that the clamping component and the corresponding carrying portion move away from each other along the second axial direction.

In an embodiment of the disclosure, the carrying structure has at least one guiding portion, the two push rods are respectively connected on opposite sides of the at least one guiding portion, and the at least one pushing assembly is suitable for moving along a direction toward the at least one guiding portion, so that the two push rods are relatively expanded by being guided by the at least one guiding portion.

In an embodiment of the disclosure, the clamping structure includes at least one fifth elastic component. The at least one fifth elastic component is connected between the at least one pushing assembly and the corresponding carrying structure, and the at least one pushing assembly is suitable for being reset along a direction away from the at least one guiding portion by an elastic force of the at least one fifth elastic component.

In an embodiment of the disclosure, a distance between the two clamping portions in the second state is greater than a distance between the two clamping portions in the first state, and the two carrying structures are suitable for relatively sliding from the second state to the first state by an elastic force of the first elastic component.

In an embodiment of the disclosure, the device body includes a positioning assembly, the positioning assembly is movably disposed on one of the carrying structures, and is suitable for resisting an elastic force of the first elastic component to position another carrying structure in the second state.

In an embodiment of the disclosure, the positioning assembly includes a push button, at least one positioning component, and a third elastic component, the push button is slidably disposed on the corresponding carrying structure, and the third elastic component is connected to the at least one positioning component. The at least one positioning component is suitable for positioning the another carrying structure by an elastic force of the third elastic component, and the push button is suitable for moving to drive the at least one positioning component to release the another carrying structure.

In an embodiment of the disclosure, the positioning assembly includes a fourth elastic component, the fourth elastic component is connected between the push button and the corresponding carrying structure, and the push button is suitable for being reset by an elastic force of the fourth elastic component.

In an embodiment of the disclosure, a distance between the clamping component located at the first position and the carrying portion is greater than a distance between the clamping component located at the second position and the carrying portion, and the clamping component is suitable for moving from the second position to the first position by an elastic force of the second elastic component.

In an embodiment of the disclosure, the clamping structure includes a positioning component, and the positioning component is disposed on the corresponding carrying structure and is suitable for resisting an elastic force of the second elastic component to position the clamping component between the first position and the second position.

In an embodiment of the disclosure, the positioning component has a first gear rack portion, the clamping component has a second gear rack portion, and the first gear rack portion and the second gear rack portion are suitable for engaging with each other to position the clamping component.

In an embodiment of the disclosure, each tooth of the first gear rack portion has a first blocking surface and a first guide inclined surface that are opposite to each other, and each tooth of the second gear rack portion has a second blocking surface and a second guide inclined surface that are opposite to each other, the first blocking surface and the second blocking surface face each other and prevent the clamping component from moving to the first position.

In an embodiment of the disclosure, the clamping structure includes at least one sixth elastic component, the at least one sixth elastic component is connected between the positioning component and the corresponding carrying structure, and the positioning component is suitable for positioning the clamping component by an elastic force of the at least one sixth elastic component.

In an embodiment of the disclosure, the device body includes an electrical connector, and the electrical connector is disposed on one of the carrying structures and is suitable for being inserted into the electronic device along the first axial direction.

In an embodiment of the disclosure, the electrical connector is pivotally connected to the corresponding carrying structure along a rotation axis, and the electrical connector is suitable for being rotated and inclined along the rotation axis.

In an embodiment of the disclosure, the electrical connector has a shaft portion, the corresponding carrying structure has a shaft hole, the shaft portion is pivotally connected to the shaft hole along the rotation axis, and a friction force between the shaft hole and the shaft portion is suitable for fixing an inclination angle of the electrical connector.

In an embodiment of the disclosure, the shaft portion has a convex point, an inner wall of the shaft hole has a concave point, and the convex point is suitable for being positioned on the concave point.

In an embodiment of the disclosure, the electrical connector has a shaft portion and is pivotally connected to the corresponding carrying structure by the shaft portion. The device body includes a torsion spring, and the torsion spring is connected between the shaft portion and the corresponding carrying structure. The electrical connector is suitable for being inclined by resisting an elastic force of the torsion spring and is suitable for being reset by the elastic force of the torsion spring.

Based on the above, the two carrying structures of the expansion device of the disclosure may relatively slide from the first state to the second state along the first axial direction with the variation of the elastic potential energy of the first elastic component. Therefore, the two carrying structures may be adjusted to a suitable state between the first state and the second state according to the dimension of the electronic device in the first axial direction, so as to clamp the electronic device in the first axial direction by the clamping portion. In addition, the clamping component of the expansion device of the disclosure may move from the first position to the second position along the second axial direction with the variation of the elastic potential energy of the second elastic component. Therefore, the clamping component may be adjusted to a suitable position between the first position and the second position according to the dimension of the electronic device in the second axial direction, so as to clamp the electronic device in the second axial direction. Accordingly, regardless of whether the electronic device is equipped with a protective case, the expansion device of the disclosure may be firmly combined with the electronic device.

### BRIEF DESCRIPTION OF THE DRAWING

FIG. 1 is a front view of an expansion device according to an embodiment of the disclosure.

FIG. 2 shows that the expansion device of FIG. 1 is combined with an electronic device.

FIG. 3 shows the relative sliding of the two carrying structures of FIG. 1.

FIG. 4A to FIG. 4D are operational flowcharts of the device body of FIG. 3.

FIG. 5 is a partial enlarged view of the first gear rack portion and the second gear rack portion of FIG. 4A.

FIG. 6 is a side view of the carrying portion of FIG. 4C carrying the electronic device.

FIG. 7 shows the clamping portion of FIG. 6 clamping the electronic device.

FIG. 8 is a partial three-dimensional view of the expansion device of FIG. 1.

FIG. 9A and FIG. 9B are operational flowcharts of the clamping structure of FIG. 8.

FIG. 10 is a side view of the carrying portion of FIG. 9B carrying the electronic device.

FIG. 11A shows the clamping portion of FIG. 10 clamping the electronic device.

FIG. 11B shows that the expansion device of FIG. 11A is combined with an electronic device equipped with a protective case.

FIG. 12 is a partial structural three-dimensional view of the expansion device of FIG. 1.

FIG. 13A and FIG. 13B show the inclination of the electrical connector of FIG. 12.

FIG. 14A and FIG. 14B respectively show the electrical connector of FIG. 13A and FIG. 13B connecting with an electronic device.

FIG. 15 is a three-dimensional view of the electrical connector and the shaft hole of the carrying structure of FIG. 12.

FIG. 16 is a side view of the electrical connector and the shaft hole of the carrying structure of FIG. 15.

FIG. 17 is a partial structural three-dimensional view of a device body according to another embodiment of the disclosure.

FIG. 18A to FIG. 18C are operational flowcharts of the device body of FIG. 17.

FIG. 19 is a partial three-dimensional view of the expansion device of FIG. 17.

FIG. 20A to FIG. 20E are operational flowcharts of the clamping structure of FIG. 19.

FIG. 21 shows that the electronic device of FIG. 20E is not equipped with a protective case.

FIG. 22 is a partial enlarged view of the first gear rack portion and the second gear rack portion of FIG. 20E.

FIG. 23 is a partial structural three-dimensional view of the expansion device of FIG. 17.

FIG. 24A and FIG. 24B show the inclination of the electrical connector of FIG. 23.

### DETAILED DESCRIPTION OF DISCLOSED EMBODIMENTS

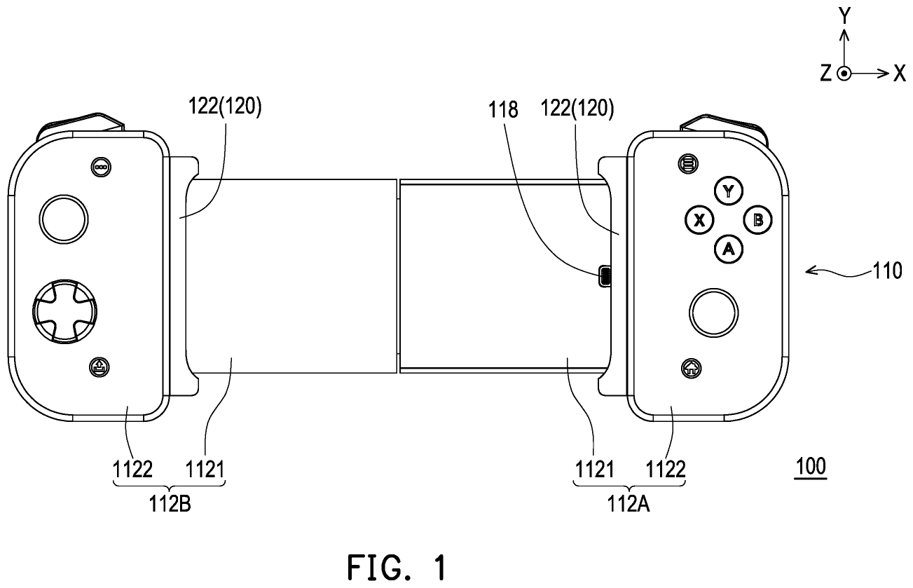

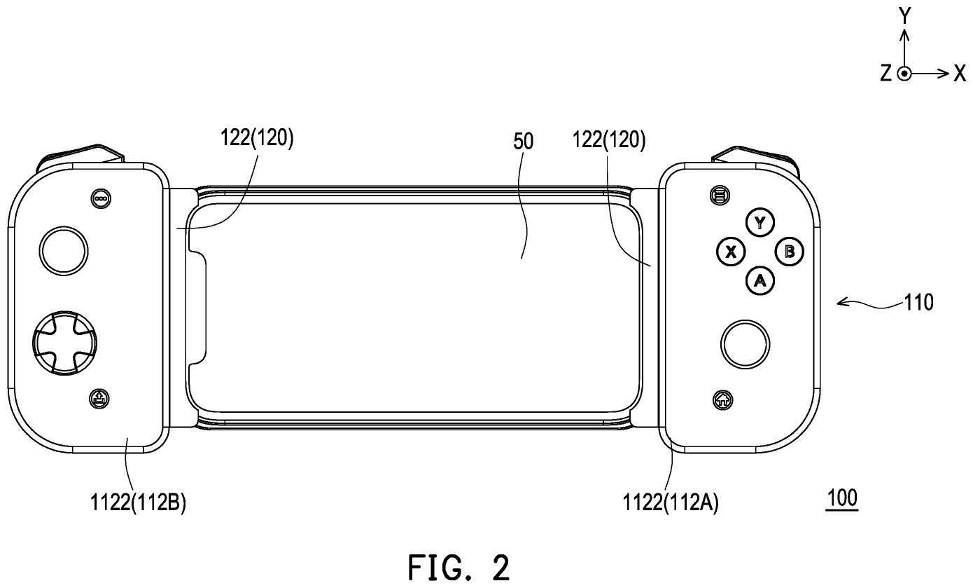

FIG. 1 is a front view of an expansion device according to an embodiment of the disclosure FIG. 2 shows that the expansion device of FIG. 1 is combined with an electronic device. Referring to FIG. 1 and FIG. 2, an expansion device 100 of the present embodiment is, for example, an expandable gaming handle, which is used to connect to an electronic device 50 such as a smartphone. The expansion device 100 includes a device body 110 and two clamping structures 120. The device body 110 includes two carrying structures 112A and 112B, and the two clamping structures 120 are respectively disposed on the two carrying structures 112A and 112B. Each of the carrying structures 112A and 112B has a carrying portion 1121 and a clamping portion 1122, and the carrying portion 1121 is used to carry the electronic device 50. The two clamping portions 1122 are, for example, a pair of gaming handle assemblies or their casings and are used to clamp the electronic device 50 in a first axial direction X, and each of the clamping structures 120 is used to jointly clamp the electronic device 50 with the carrying portion 1121 along a second axial direction Z perpendicular to the first axial direction X.

The specific manner in which the clamping portion 1122 clamps the electronic device in the first axial direction X is described below.

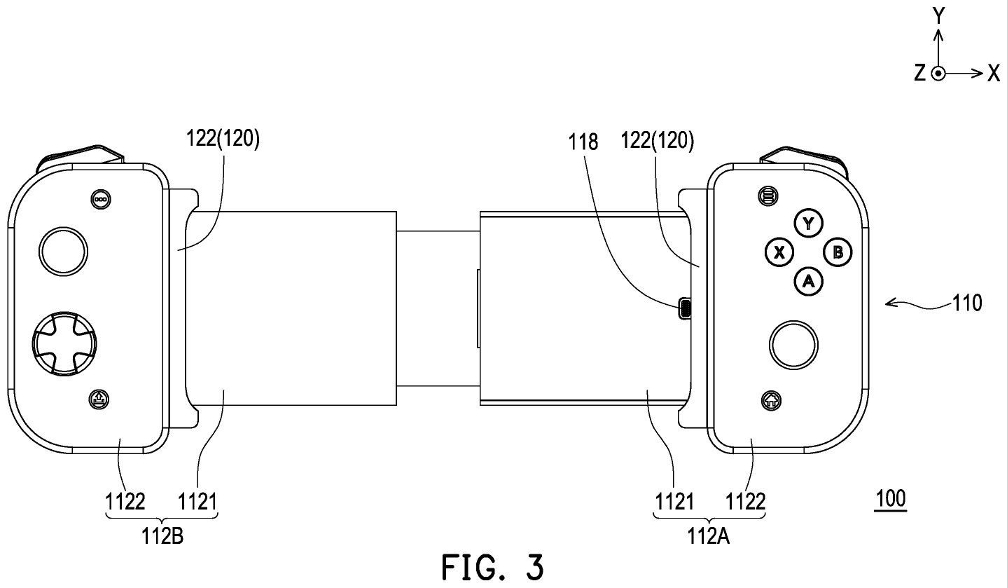

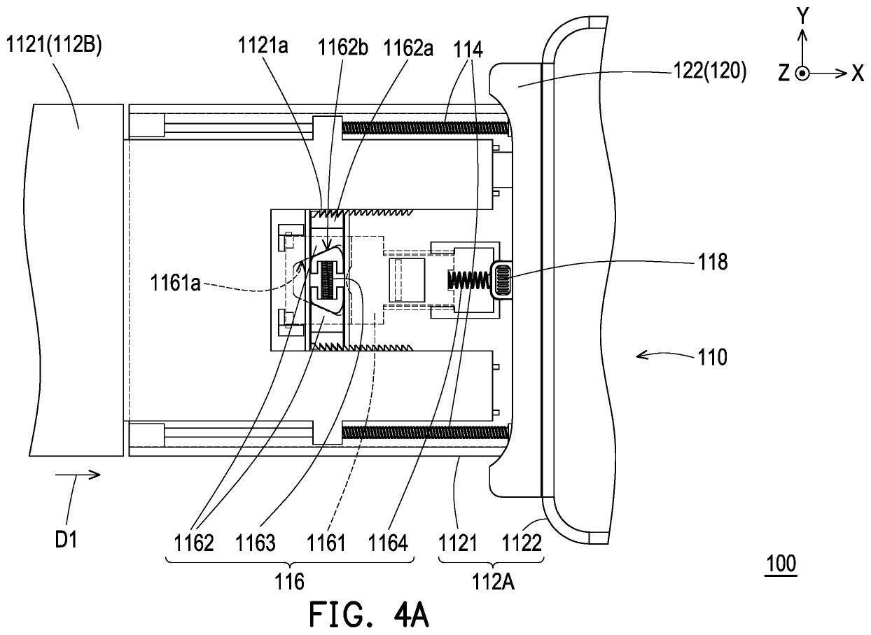

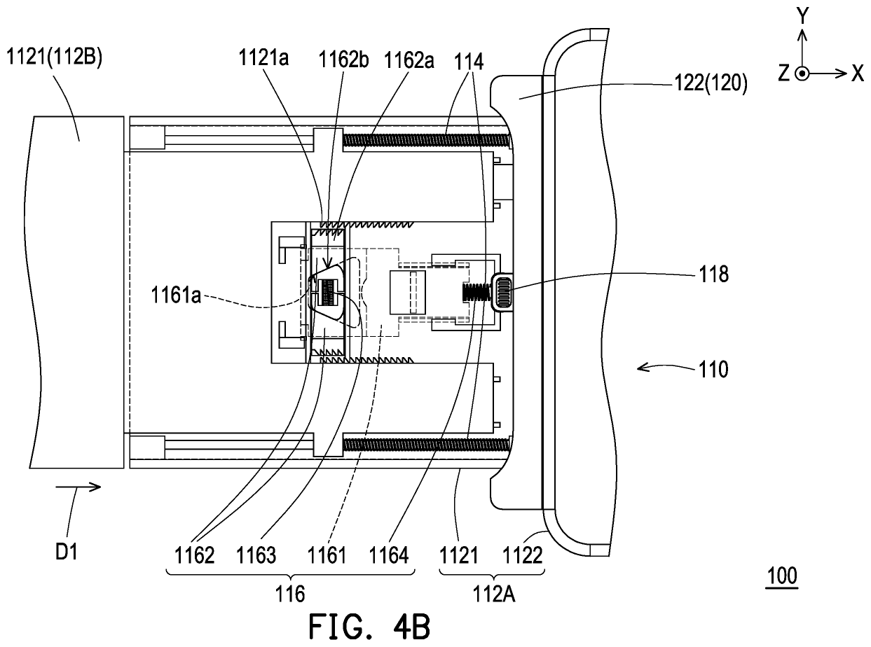

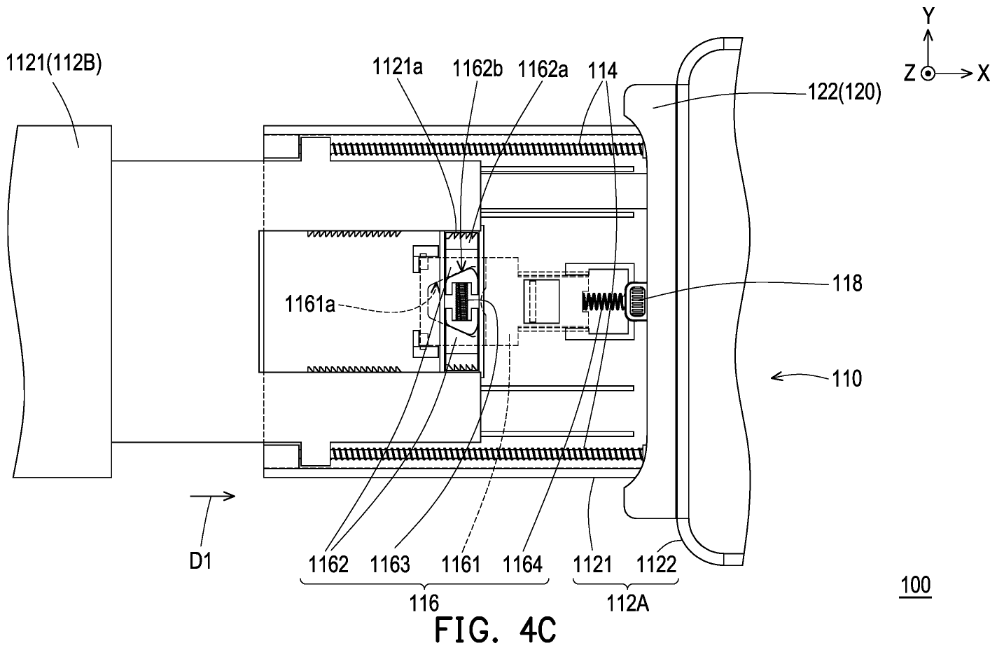

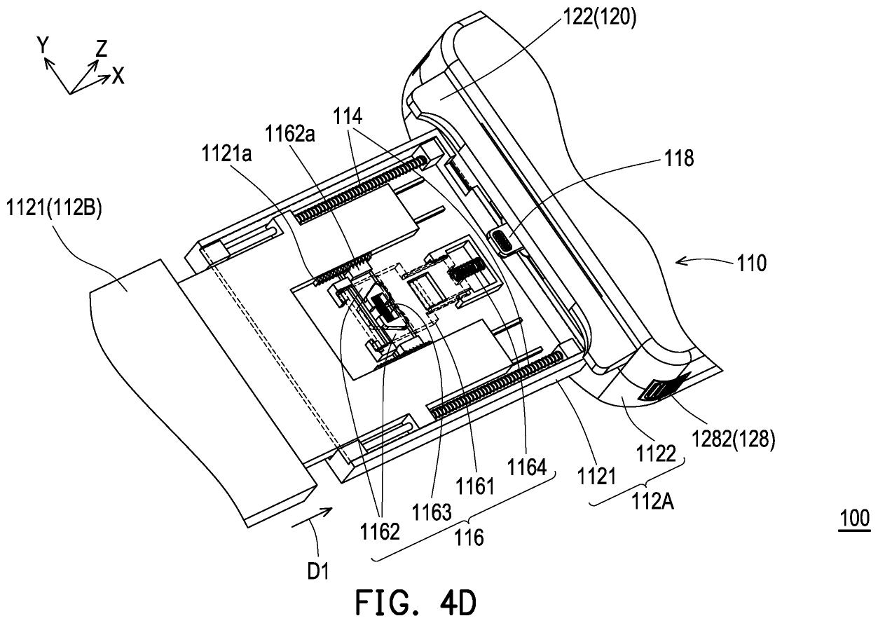

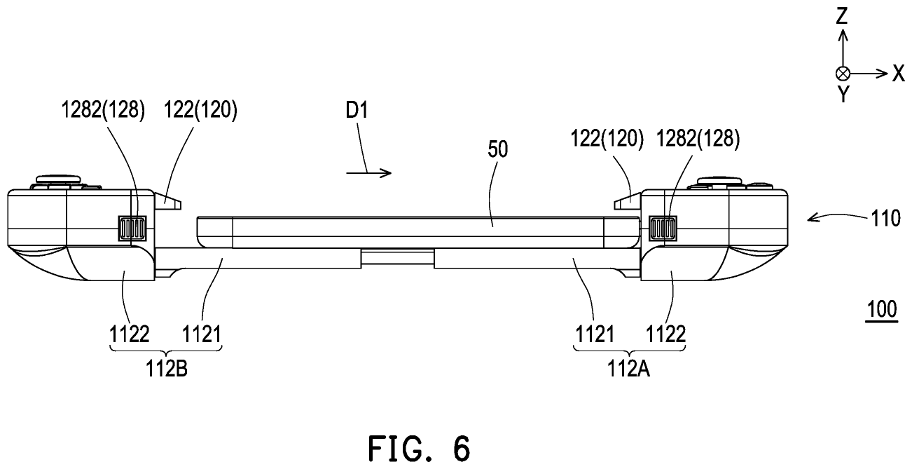

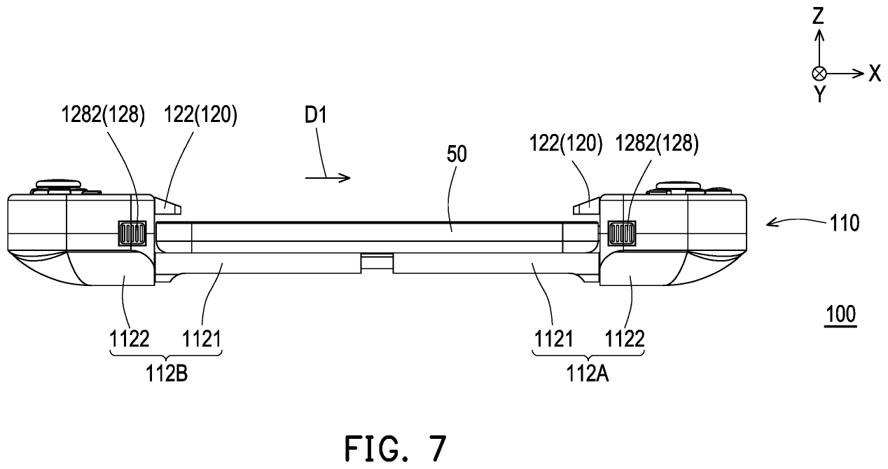

FIG. 3 shows the relative sliding of the two carrying structures of FIG. 1. FIG. 4A to FIG. 4D are operational flowcharts of the device body of FIG. 3. FIG. 6 is a side view of the carrying portion of FIG. 4C carrying the electronic device. FIG. 7 shows the clamping portion of FIG. 6 clamping the electronic device. The two carrying structures 112A and 112B in this embodiment are slidably disposed on each other along the first axial direction X. As shown in FIG. 4A, the device body 110 includes at least one first elastic component 114 (two are shown) and a positioning assembly 116. The first elastic component 114 is, for example, a compression spring and is connected between the two carrying structures 112A and 112B. The positioning assembly 116 is movably disposed on the carrying structure 112A.

When the expansion device 100 is in the state shown in FIG. 1, the positioning assembly 116 may position the carrying structure 112B as shown in FIG. 4A. When the positioning component 116 releases its positioning on the carrying structure 112B as shown in FIG. 4B, the two carrying structures 112A and 112B may relatively slide from the first state shown in FIG. 1 and FIG. 4B to the second state shown in FIG. 3 and FIG. 4C by the elastic force of the first elastic component 114. The distance between the two clamping portions 1122 in the second state is greater than the distance between the two clamping portions 1122 in the first state. In the second state, the user may place the electronic device 50 on the two carrying portions 1121 as shown in FIG. 6. The positioning component 116 may resist the elastic force of the first elastic component 114 to position the carrying structure 112B between the first state and the second state as shown in FIG. 4D, so that the two clamping portions 1122 may clamp the electronic device 50 between the first state and the second state as shown in FIG. 7. When the positioning assembly 116 releases its positioning on the carrying structure 112B, the two carrying structures 112A and 112B may be reset to the second state shown in FIG. 6 by the elastic force of the first elastic component 114, so that the two clamping portions 1122 release the electronic device 50.

The specific manner in which the clamping structure 120 clamps the electronic device 50 in the second axial direction Z is described below.

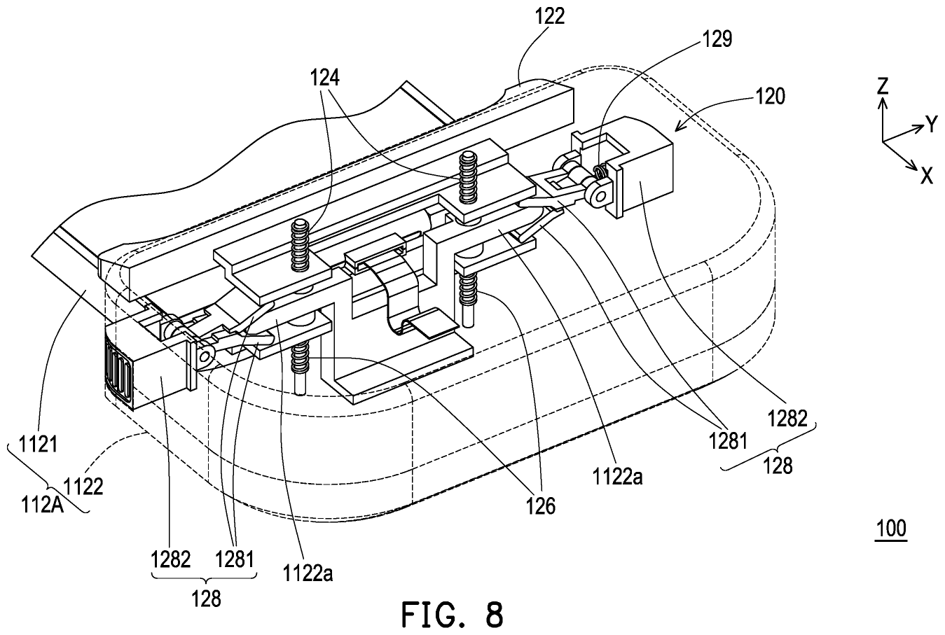

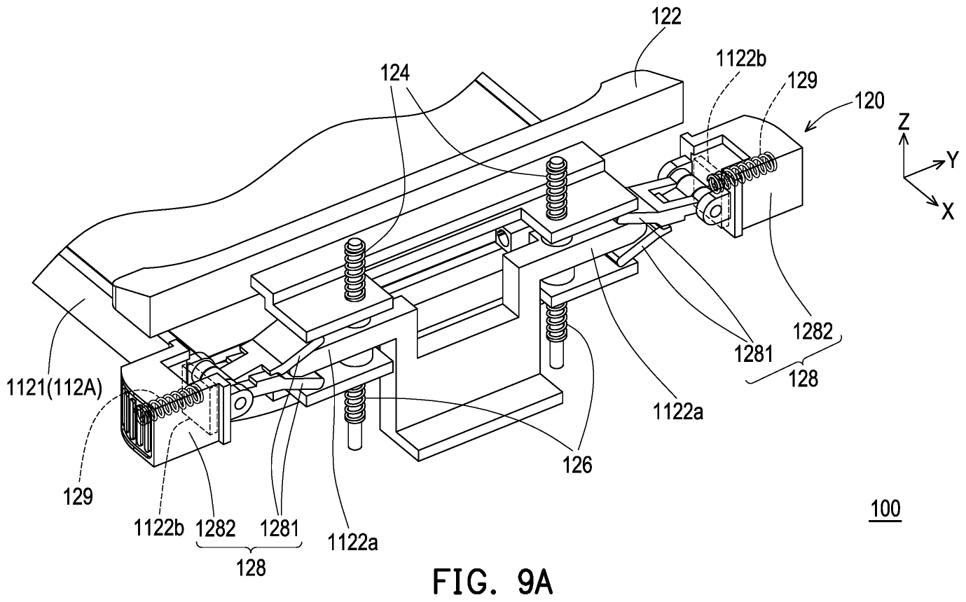

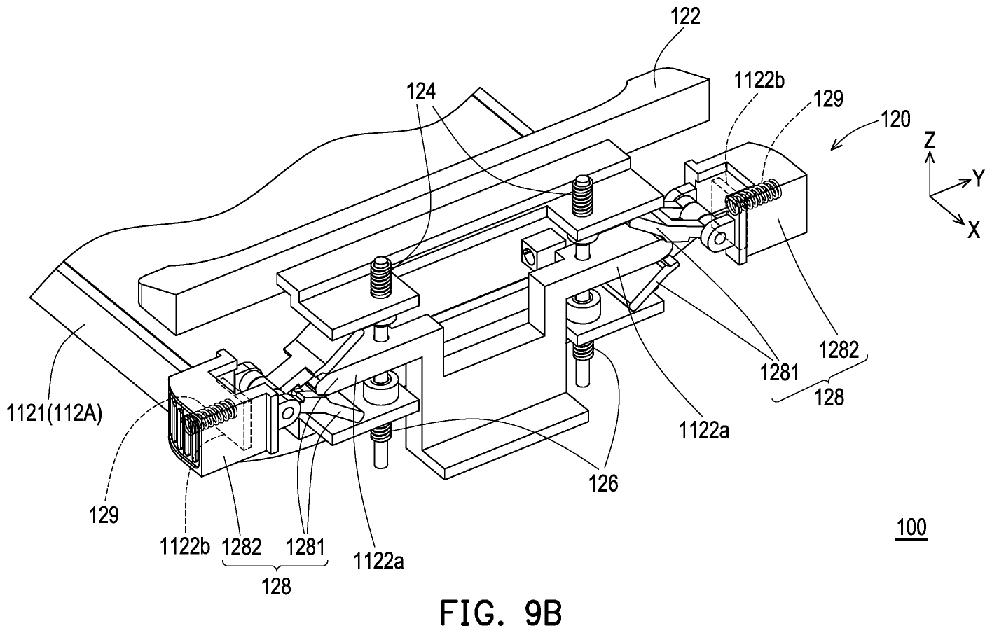

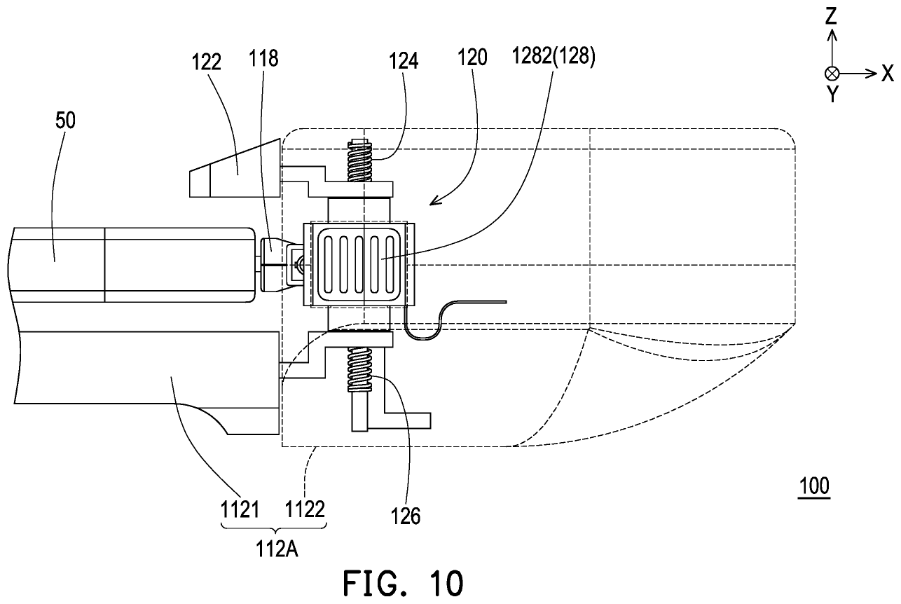

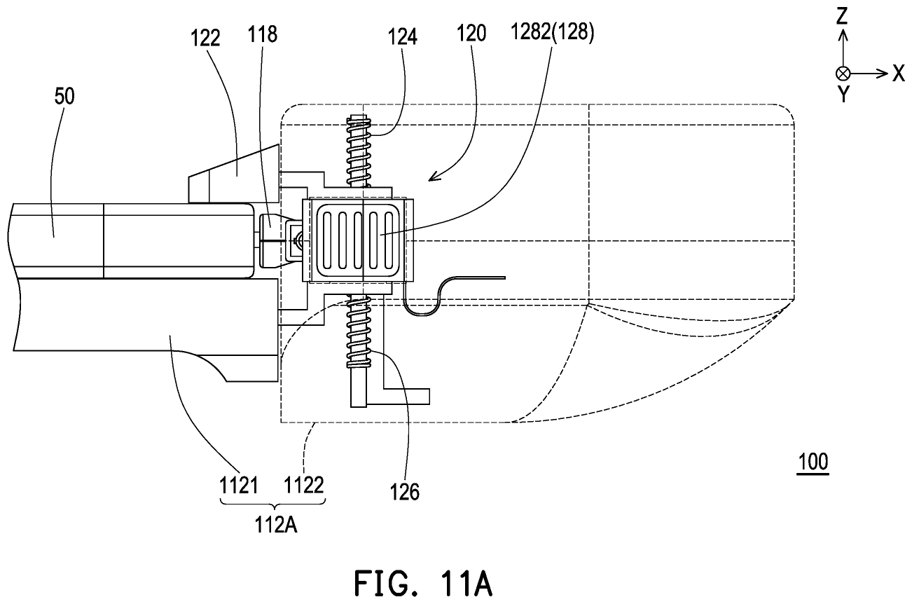

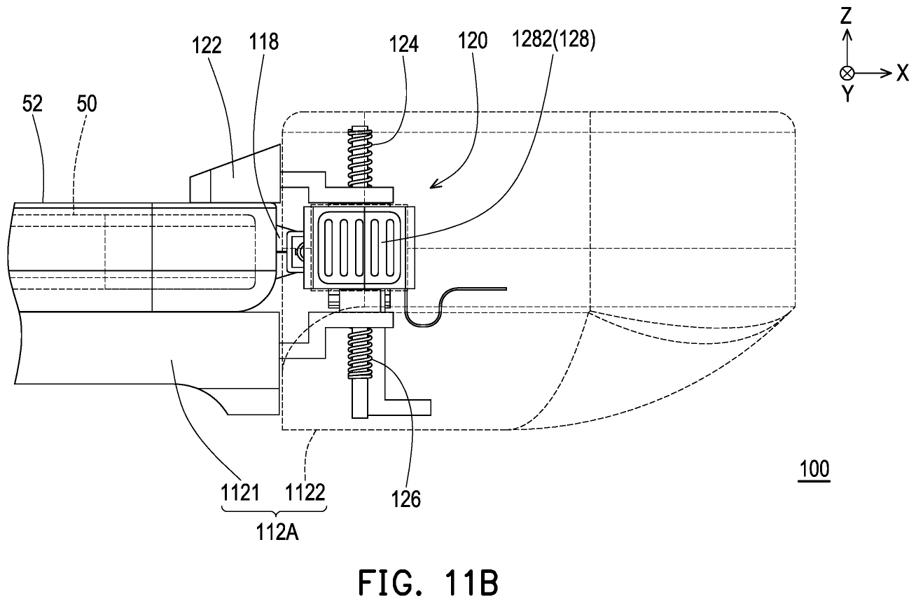

FIG. 8 is a partial three-dimensional view of the expansion device of FIG. 1. FIG. 9A and FIG. 9B are operational flowcharts of the clamping structure of FIG. 8. FIG. 10 is a side view of the carrying portion of FIG. 9B carrying the electronic device. FIG. 11A shows the clamping portion of FIG. 10 clamping the electronic device. As shown in FIG. 8, the clamping structure 120 of this embodiment includes a clamping component 122, at least one second elastic component 124, and at least one second elastic component 126 (shown as multiple second elastic components 124 and multiple second elastic components 126), and at least one pushing assembly 128 (two are shown). The clamping component 122 is movably disposed in the clamping portion 1122 of a carrying structure 112A along the second axial direction Z, and the clamping portion 1122 and the carrying portion 1121 are movably connected to each other along the second axial direction Z. The second elastic component 124 is, for example, a compression spring and is connected between the clamping component 122 and the clamping portion 1122 of the carrying structure 112A. The second elastic component 126 is, for example, a compression spring and is connected between the clamping portion 1122 and the carrying portion 1121. The pushing assembly 128 is movably disposed on the clamping portion 1122 of the carrying structure 112A.

The pushing assembly 128 may resist the elastic force of the second elastic components 124 and 126 to push the clamping component 122 and the carrying portion 1121 relative to the clamping portion 1122 from the second position shown in FIG. 9A to the first position shown in FIG. 9B. The distance between the clamping component 122 and the carrying portion 1121 at the first position is greater than the distance between the clamping component 122 and the carrying portion 1121 at the second position. The user may place the clamping component 122 and the carrying portion 1121 in the first position by pressing the pushing assembly 128, as shown in FIG. At this time, there is a sufficient distance between the clamping component 122 and the carrying portion 1121 such that the user may place the electronic device 50 on the carrying portion 1121. Then, the user may release the pushing assembly 128 so that the clamping component 122 and the carrying portion 1121 move from the first position to the second position by the elastic force of the second elastic components 124 and 126, therefore, as shown in FIG. 11A, the clamping component 122 and the carrying portion 1121 jointly clamp the electronic device 50 between the first position and the second position by the elastic force of the second elastic components 124 and 126.

As described above, the two carrying structures 112A and 112B of the expansion device 100 of this embodiment may relatively slide from the first state to the second state along the first axial direction X with the variation of the elastic potential energy of the first elastic component 114. Therefore, the two carrying structures 112A and 112B may be adjusted to a suitable state between the first state and the second state according to the dimension of the electronic device 50 in the first axial direction X, so as to clamp the electronic device 50 in the first axial direction X by the clamping portion 1122. In addition, the clamping component 122 of the expansion device 100 of the present embodiment may move from the first position to the second position along the second axial direction Z with the variation of the elastic potential energy of the second elastic component 124. Therefore, the clamping component 122 may be adjusted to a suitable position between the first position and the second position according to the dimension of the electronic device 50 in the second axial direction Z, so as to clamp the electronic device 50 in the second axial direction Z. Therefore, according to the different dimensions of the electronic device 50, the expansion device 100 of this embodiment may be firmly combined with the electronic device 50.

FIG. 11B shows that the expansion device of FIG. 11A is combined with an electronic device equipped with a protective case. For example, when the electronic device 50 is equipped with a protective case 52 as shown in FIG. 11B and the dimensions in the first axial direction X and the second axial direction Z are increased, the clamping portion 1122 and the clamping component 122 may smoothly clamp the protective case 52 of the electronic device 50 by adjusting the positions and states described above.

The detailed configuration and actuation of the positioning assembly 116 of the device body 110 of the present embodiment are further described below.

Referring to FIG. 4A, the positioning assembly 116 of this embodiment includes a push button 1161, two positioning components 1162, a third elastic component 1163, and a fourth elastic component 1164. The push button 1161 is slidably disposed on the carrying portion 1121 of the carrying structure 112A along the first axial direction X, and is configured to move along a first direction D1 by the force applied by the user. In this embodiment, the positioning assembly 116 is disposed in the carrying structure 112A, and the first direction D1 is the direction in which the carrying structure 112A is moving away from the carrying structure 112B. The positioning component 1162 is slidably disposed on the carrying portion 1121 of the carrying structure 112A along a third axial direction Y, the third elastic component 1163 is, for example, a compression spring and is connected between two positioning components 1162, and the fourth elastic component 1164 is, for example, a compression spring and is connected between the push button 1161 and the carrying portion 1121 of the carrying structure 112A.

The two positioning components 1162 may position the carrying portion 1121 of the carrying structure 112B as shown in FIG. 4A or FIG. 4D by the elastic force of the third elastic component 1163. Specifically, each of the positioning components 1162 has a first gear rack portion 1162a, the carrying portion 1121 of the carrying structure 112B has a second gear rack portion 1121a, and the first gear rack portion 1162a and the second gear rack portion 1121a are suitable for engaging with each other to position the carrying portion 1121 of the carrying structure 112B.

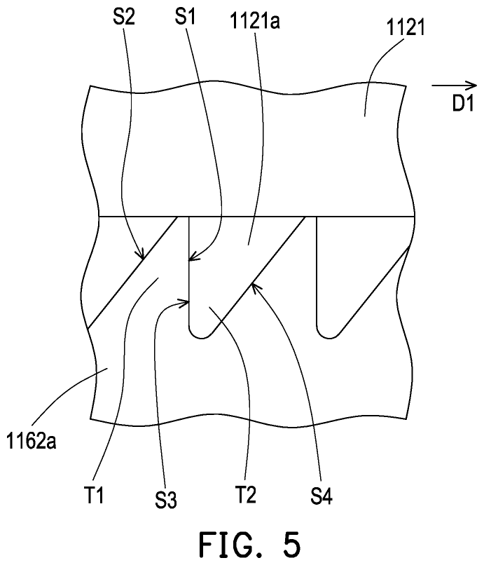

FIG. 5 is a partial enlarged view of the first gear rack portion and the second gear rack portion of FIG. 4A. Referring to FIG. 5, in more detail, each tooth T1 of the first gear rack portion 1162a has a first blocking surface S1 and a first guide inclined surface S2 that are opposite to each other, and each tooth T2 of the second gear rack portion 1121a has a second blocking surface S3 and a second guide inclined surface S4 that are opposite to each other. The first blocking surface S1 and the second blocking surface S3 face each other and prevent the carrying structure 112B from moving to the first state in a direction opposite to the first direction D1. The first guide inclined surface S2 and the second guide inclined surface S4 face each other. When the user applies force on the carrying structure 112B along the first direction D1, the carrying structure 112B may be moved to a suitable position along the first direction D1 to clamp the electronic device 50 by being guided by the first guide inclined surface S2 and the second guide inclined surface S4 and slightly elastically deforming the structure.

On the other hand, the push button 1161 may resist the elastic force of the fourth elastic component 1164 to move along the first direction D1 as shown in FIG. 4B by the force of the user, so as to drive the two positioning components 1162 to approach each other along the direction parallel to the third axial direction Y to be separated from the carrying portion 1121 of the carrying structure 112B. In addition, the push button 1161 may be reset in a direction opposite to the first direction D1 by the elastic force of the fourth elastic component 1164. Specifically, the push button 1161 has two inclined surfaces 1161a, and each of the positioning components 1162 has a corresponding inclined surface 1162b. The push button 1161 may drive the positioning component 1162 to actuate as described above by pushing the inclined surface 1161a against the inclined surface 1162b.

The detailed configuration and actuation of the pushing assembly 128 of the clamping structure 120 of the present embodiment are further described below.

Referring to FIG. 9A, each of the pushing assemblies 128 in this embodiment includes two push rods 1281 and a button 1282. The two push rods 1281 are pivotally connected to each other and connected to the button 1282. The clamping portion 1122 of the carrying structure 112 has two guiding portions 1122a. The two guiding portions 1122a are, for example, components extending from the casing of the clamping portion 1122 or components assembled in the casing, which respectively correspond to the two pushing assemblies 128. The two push rods 1281 are respectively overlapped with the upper and lower opposite sides of the corresponding guiding portion 1122a. The user may press the button 1282 to drive the pushing assembly 128 to move along the guiding portion 1122a in the third axial direction Y, so that the two push rods 1281 are relatively expanded by being guided by the guiding portion 1122a to respectively push against the clamping component 122 and the corresponding carrying portion 1121. Therefore, the clamping component 122 and the corresponding carrying portion 1121 move away from each other along the second axial direction Z.

In addition, in this embodiment, the clamping structure 120 includes two fifth elastic components 129, and the two fifth elastic components 129 respectively correspond to the two pushing assemblies 128. Each of the fifth elastic components 129 is connected between the corresponding button 1282 of the pushing assembly 128 and the blocking wall 1122b of the clamping portion 1122 of the corresponding carrying structure (shown as the carrying structure 112A in FIG. 8, FIG. 9A, and FIG. 9B). The blocking wall 1122b is, for example, a component extending from the casing of the clamping portion 1122 or a component assembled in the casing. The pushing assembly 128 may be reset along the direction moving away from the guiding portion 1122a by the elastic force of the fifth elastic component 129.

The following describes the manner in which the expansion device 100 of this embodiment is electrically connected to the electronic device 50.

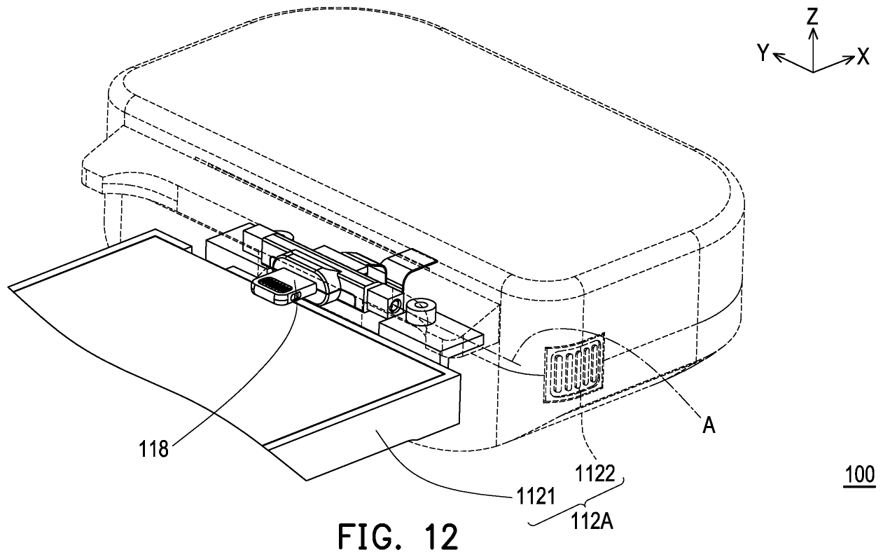

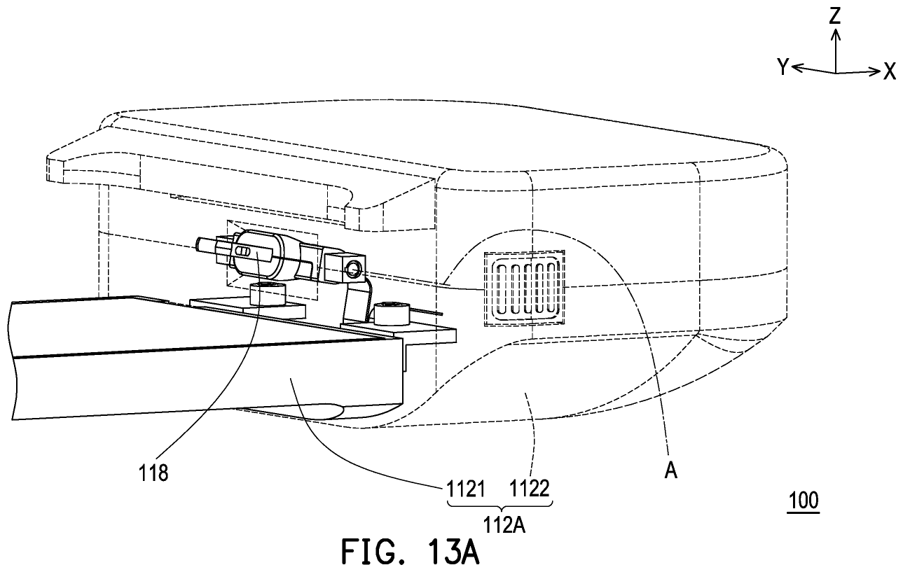

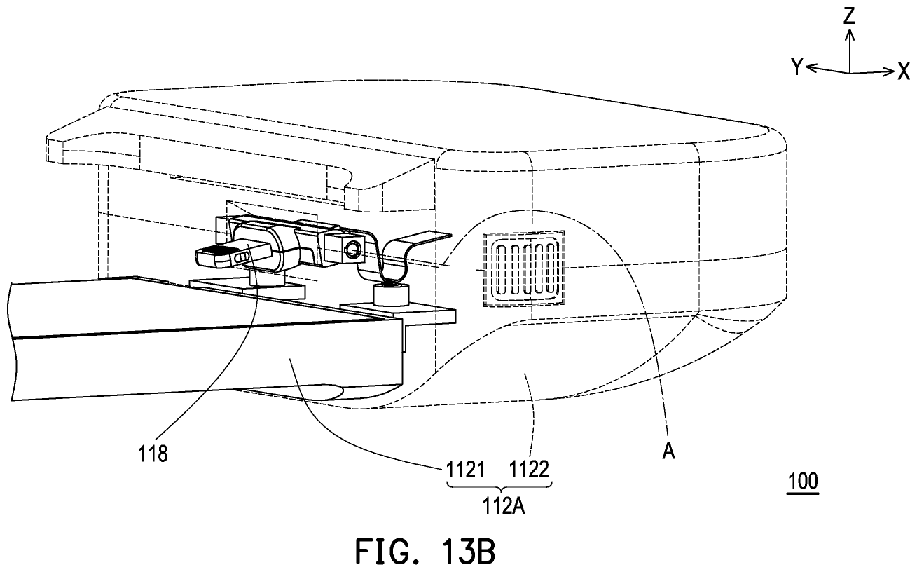

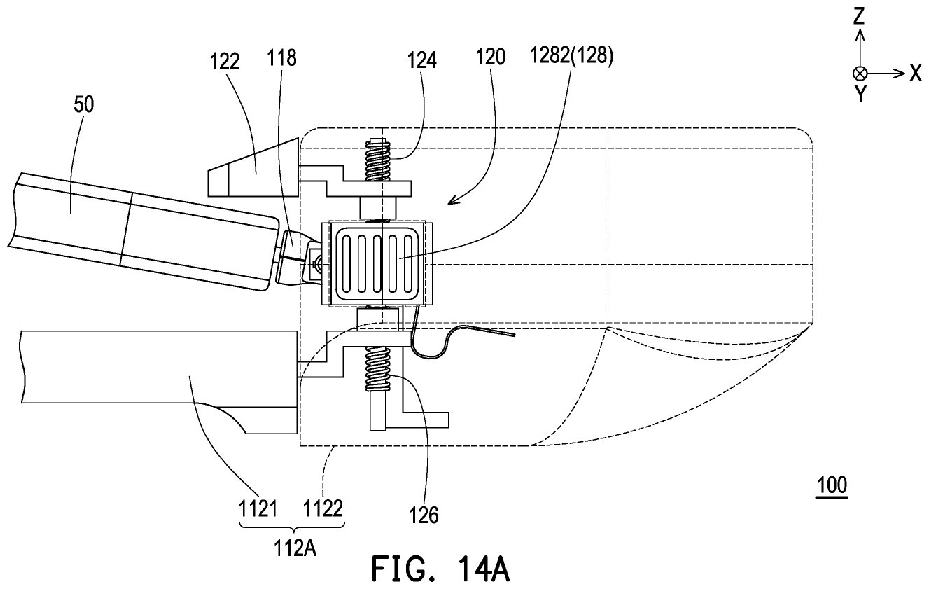

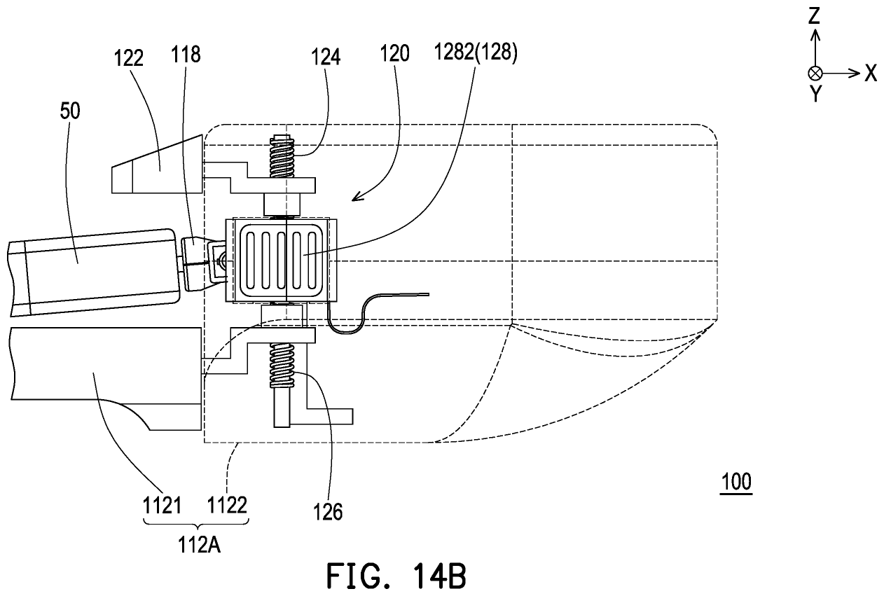

FIG. 12 is a partial structural three-dimensional view of the expansion device of FIG. 1. FIG. 13A and FIG. 13B show the inclination of the electrical connector of FIG. 12. FIG. 14A and FIG. 14B respectively show the electrical connector of FIG. 13A and FIG. 13B connecting with an electronic device. Referring to FIG. 12, the device body 110 of the present embodiment includes an electrical connector 118. The electrical connector 118 is disposed on the carrying structure 112A and may be inserted into the electronic device 50 along the first axial direction X. Further, the electrical connector 118 is pivotally connected to the clamping portion 1122 of the carrying structure 112A along a rotation axis A parallel to the third axial direction Y, and may be rotated along the rotation axis A to be inclined as shown in FIG. 13A or FIG. 13B. Therefore, even though the electrical connector 118 may be pressed by an external force when the electronic device 50 is installed, because the electrical connector 118 may be inclined as shown in FIG. 14A or FIG. 14B without bending the electrical connector 118 or damaging the terminal of the electronic device 50, the durability of the expansion device 100 and the electronic device 50 is improved.

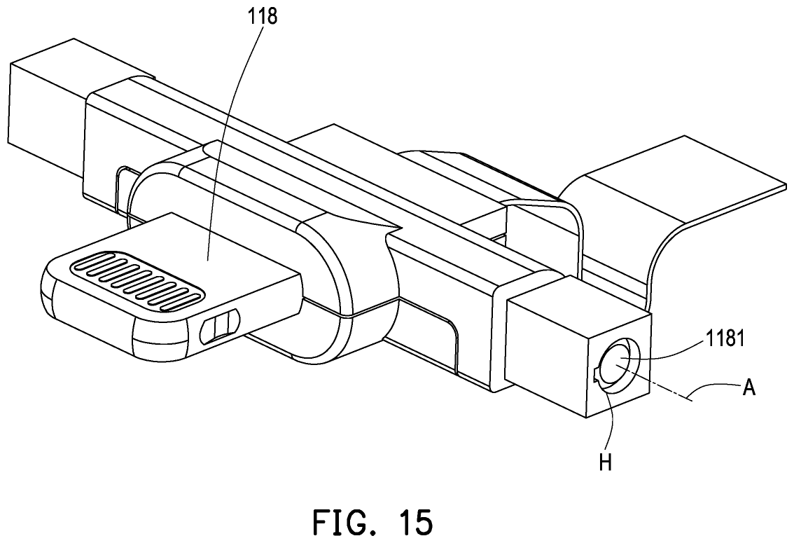

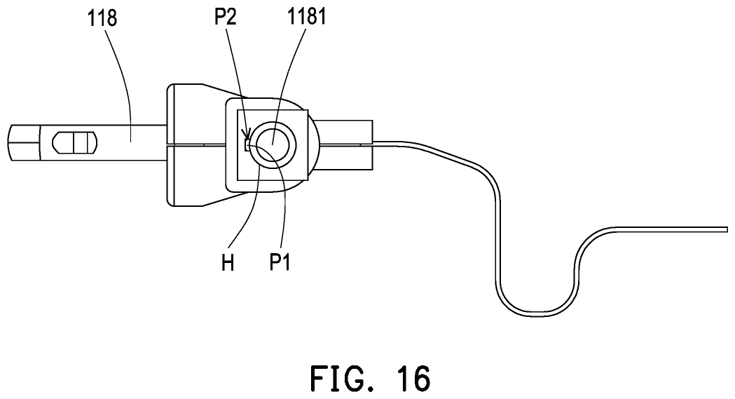

FIG. 15 is a three-dimensional view of the electrical connector and the shaft hole of the carrying structure of FIG. 12. FIG. 16 is a side view of the electrical connector and the shaft hole of the carrying structure of FIG. 15. Referring to FIG. 15 and FIG. 16, in this embodiment, the electrical connector 118 has a shaft portion 1181, the clamping portion 1122 of the carrying structure 112A has a shaft hole H, and the shaft portion 1181 is pivotally connected to the shaft hole H along the rotation axis A. The frictional force between the shaft hole H and the shaft portion 1181 may fix the inclination angle of the electrical connector 118. In addition, the shaft portion 1181 has a convex point P1, and the inner wall of the shaft hole H has a concave point P2. When the electrical connector 118 is in a horizontal state, the convex point P1 may be positioned on the concave point P2, so that the user may be sure that the electrical connector 118 is in a horizontal state.

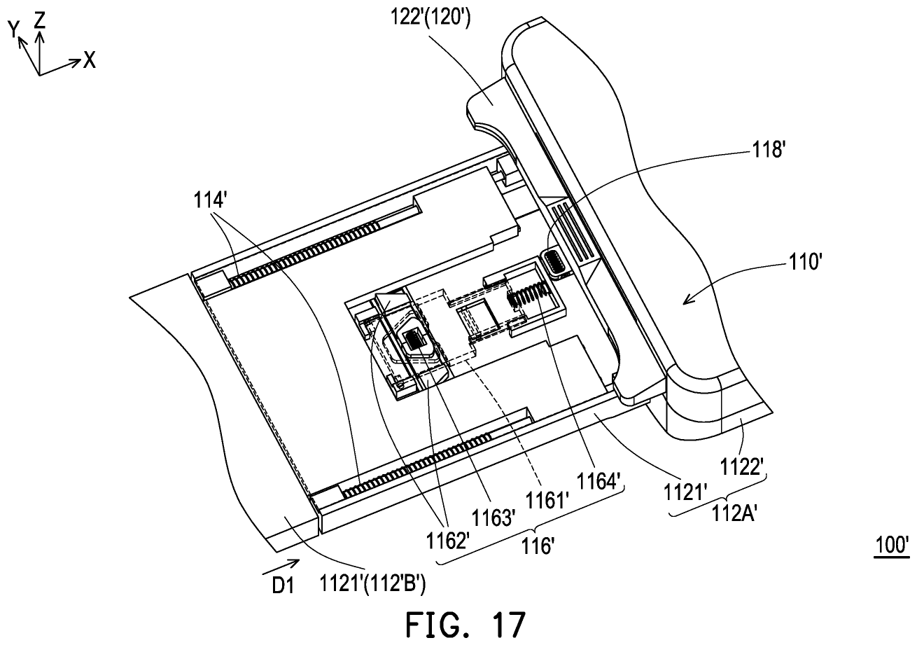

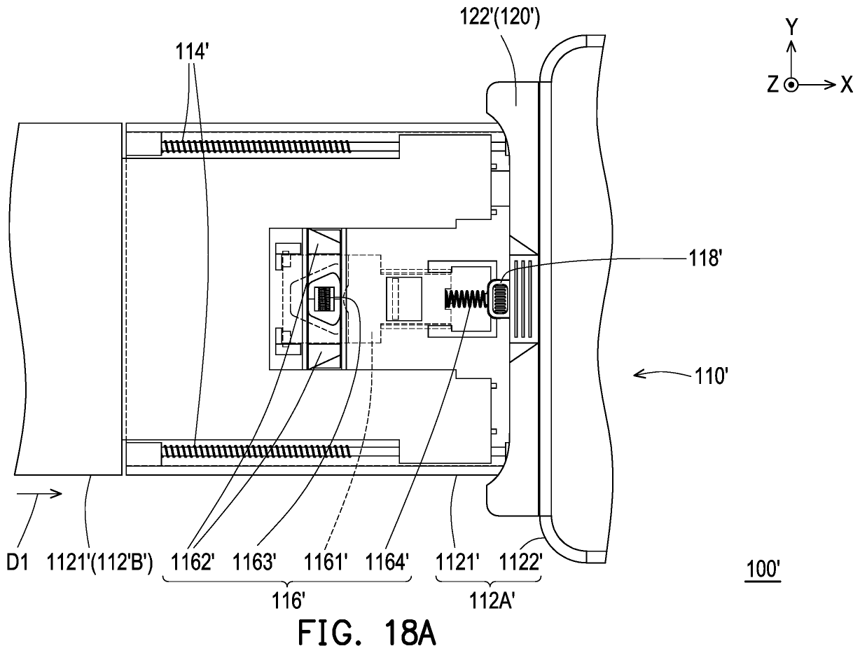

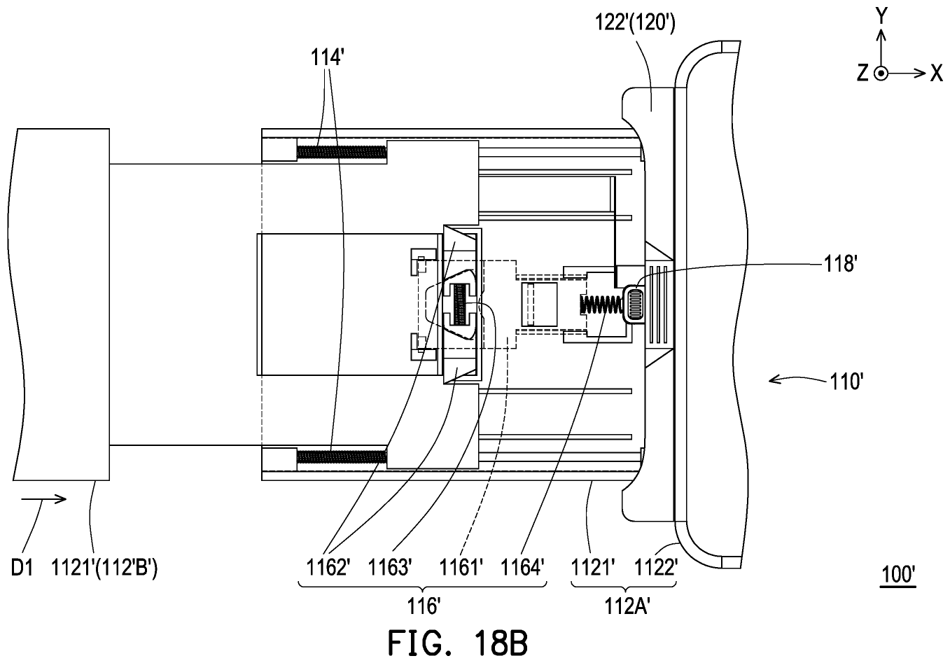

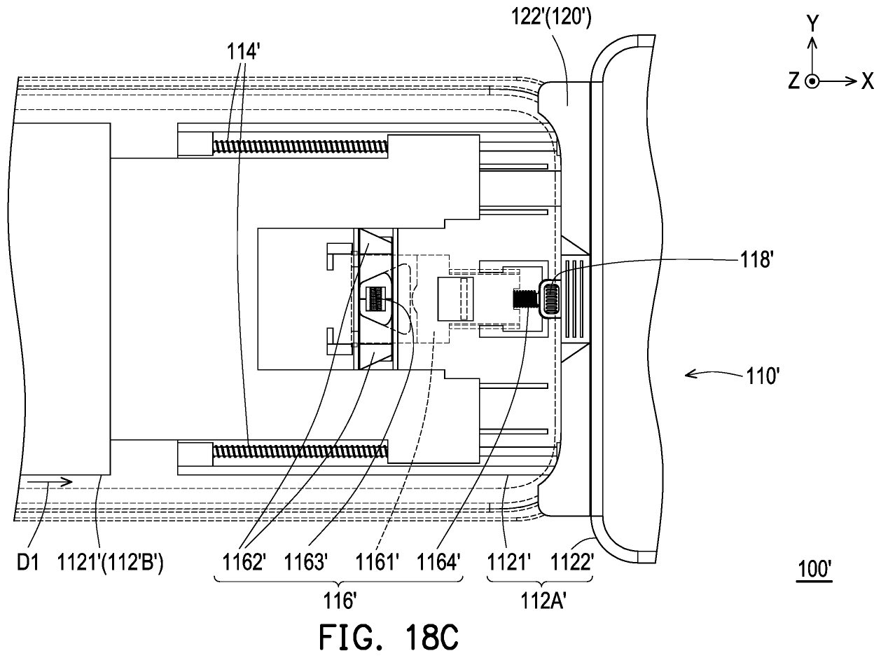

FIG. 17 is a partial structural three-dimensional view of a device body according to another embodiment of the disclosure. FIG. 18A to FIG. 18C are operational flowcharts of the device body of FIG. 17. An expansion device 100′ shown in FIG. 17 to FIG. 18C is substantially similar in configuration and actuation to the expansion device 100 of the previous embodiment. The same or similar components are represented by the same or similar component symbols, and the description of the same configuration and actuation are not be repeated thereafter.

Referring to FIG. 17, one of the main differences between the expansion device 100′ and the expansion device 100 is that the two carrying structures 112A′ and 112B′ of the expansion device 100′ may slide relatively from the second state shown in FIG. 18B (corresponding to the state shown in FIG. 3) to the first state shown in FIG. 18A (corresponding to the state shown in FIG. 1) by the elastic force of the first elastic component 114′. That is, the elastic force of the first elastic component 114′ of the expansion device 100′ is used to drive the two carrying structures 112A′ and 112B′ to retract, rather than the elastic force of the first elastic component 114 of the expansion device 100, which is used to drive the two carrying structures 112A and 112B to expand.

Based on the above differences between the expansion device 100′ and the expansion device 100, the manner of positioning of the positioning assembly 116′ and the positioning assembly 116 are also slightly different. Specifically, the user may resist the elastic force of the first elastic component 114′ to pull the carrying structure 112B′ in a direction opposite to the first direction D1, so that the carrying structure 112B′ is moved from the first state shown in FIG. 18A to the second state shown in FIG. 18B. At this time, the two positioning components 1162′ of the positioning assembly 116′ move away from each other along the direction parallel to the third axial direction Y by the elastic force of the third elastic component 1163′, so as to resist the elastic force of the first elastic component 114′ to position the carrying structure 112B′ in the second state as shown in FIG. 18B. In the second state, the user may place the electronic device 50 on the carrying structures 112A′ and 112B′ (as shown in FIG. 6), and then resist the elastic force of the fourth elastic component 1164′ by applying force on the push button 1161′, so that the push button 1161′ moves along the first direction D1 to drive the two positioning components 1162′ to approach each other along the direction parallel to the third axial direction Y as shown in FIG. 18C to release the carrying structure 112B, so that the carrying structure 112B moves along the first direction D1 until the electronic device 50 is clamped (as shown in FIG. 7).

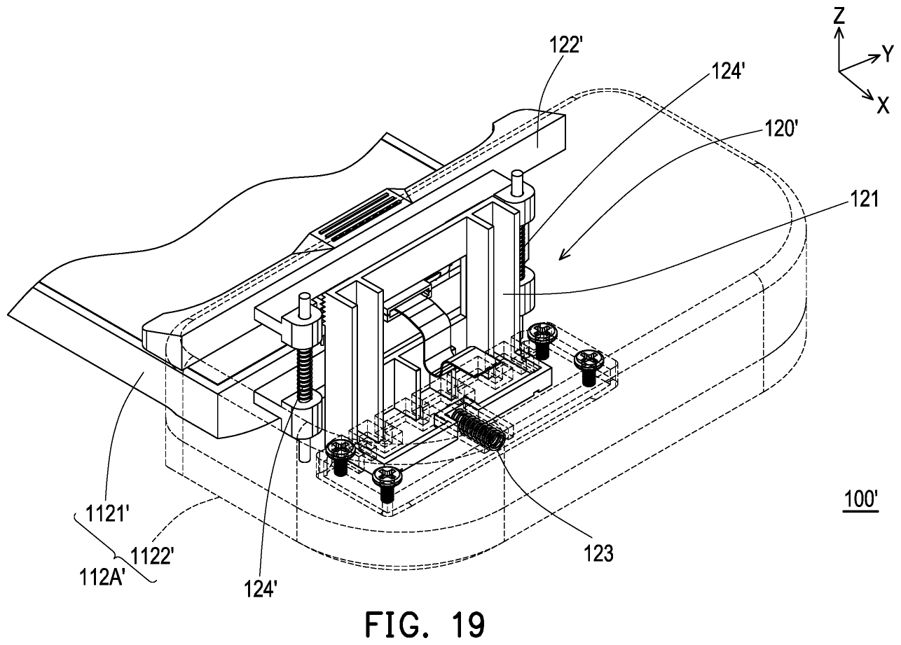

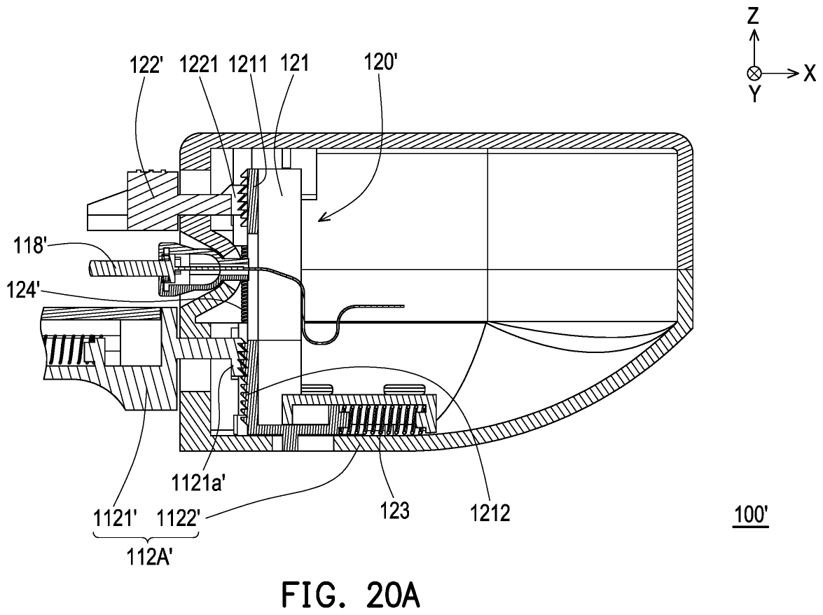

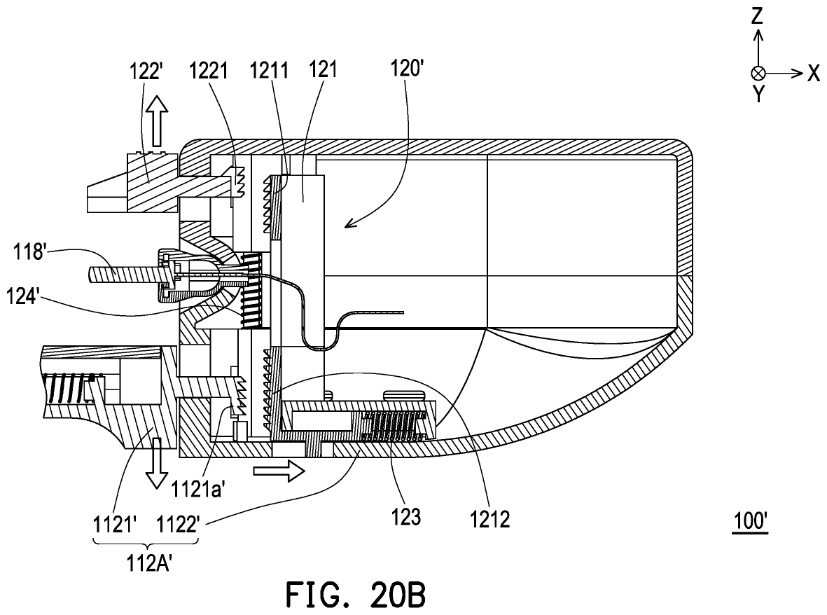

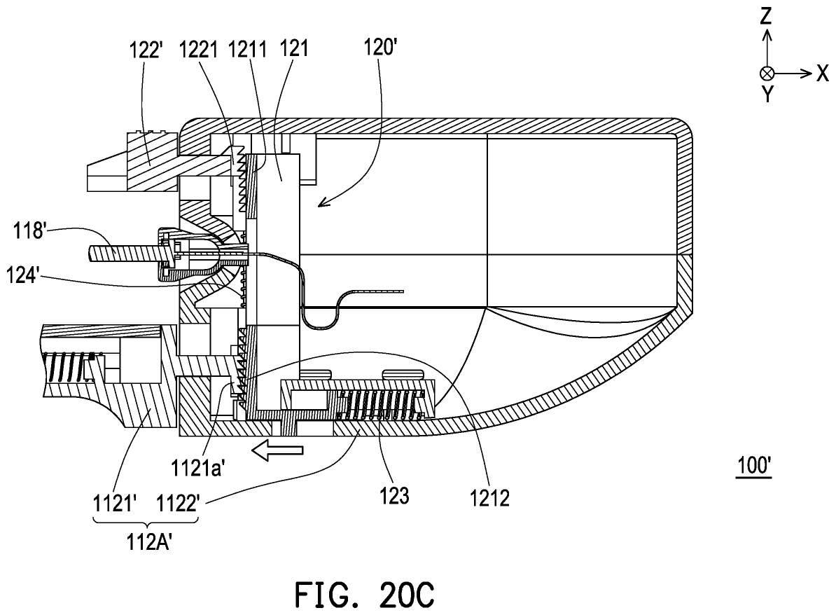

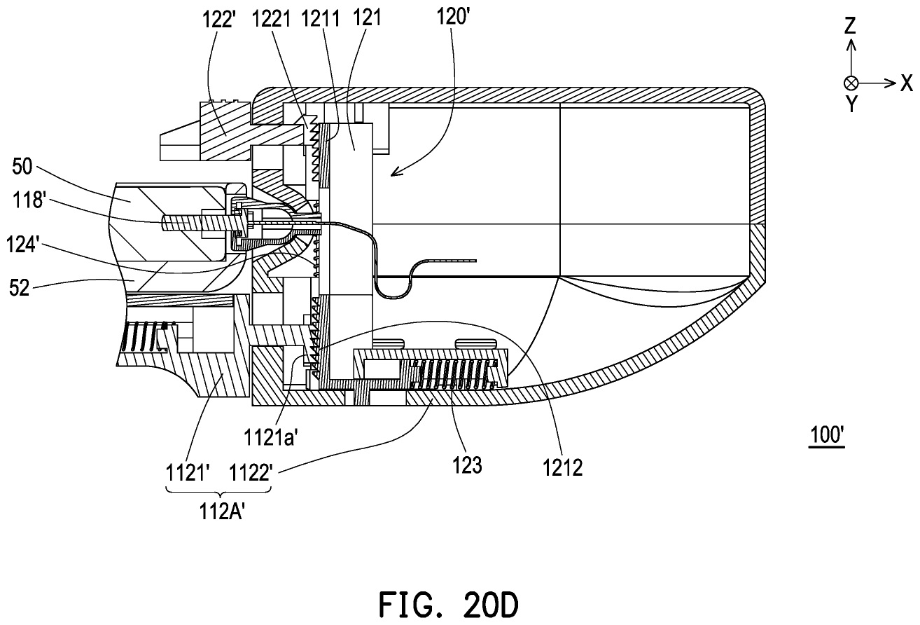

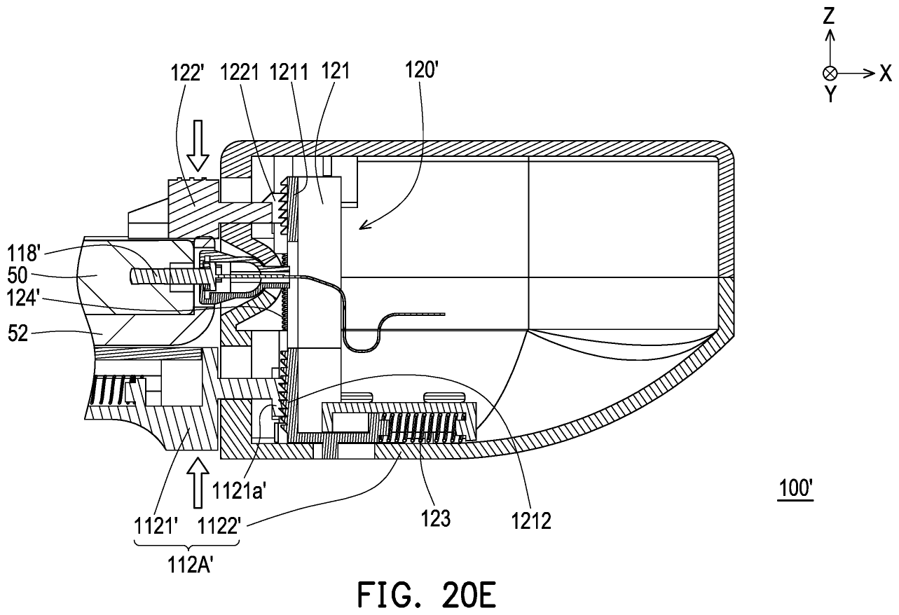

FIG. 19 is a partial three-dimensional view of the expansion device of FIG. 17. FIG. to FIG. 20E are operational flowcharts of the clamping structure of FIG. 19. Another main difference between the expansion device 100′ and the expansion device 100 is that the clamping component 122′ of the clamping structure 120′ of the expansion device 100′ may be moved from the second position shown in FIG. 20A to the first position shown in FIG. 20B by the elastic force of the second elastic component 124′. That is, the elastic force of the second elastic component 124′ of the expansion device 100′ is used to drive the clamping component 122′ to expand, rather than the elastic force of the second elastic component 124 of the expansion device 100, which is used to drive the clamping component 122 to retract. In addition, the second elastic component 124′ of the expansion device 100′ is directly compressed between the clamping component 122 and the carrying portion 1121, and the disposition of the second elastic component 126 in the above-mentioned embodiment is omitted.

Based on the above differences between the expansion device 100′ and the expansion device 100, the pushing assembly 128 is not required to be disposed in the expansion device 100′ like the expansion device 100. Instead, a positioning component 121 for positioning the clamping component 122′ and a sixth elastic component 123 for applying force to the positioning component 121 are required to be disposed in each of the clamping structures 120′.

Specifically, the positioning component 121 is movably disposed in the clamping portion 1122′ of the corresponding carrying structure (shown as the carrying structure 112A′ in FIG. 19 to FIG. 20E) along the first axial direction X, and the sixth elastic component 123 is connected between the positioning component 121 and the clamping portion 1122′ of the carrying structure 112A′. As shown in FIG. 20A, the sixth elastic component 123 pushes the positioning component 121 against the clamping component 122′ and the carrying portion 1121′ by its elastic force, so that the positioning component 121 resists the elastic force of the second elastic component 124′ to position the clamping component 122′ and the carrying portion 1121′ at the second position. The user may resist the elastic force of the sixth elastic component 123 and apply force on the positioning component 121, so that the positioning component 121 is moved away from the clamping component 122′ and the carrying portion 1121′ along the first axial direction X as shown in FIG. 20B, so that the clamping component 122′ and the carrying portion 1121′ are moved to the first position by the elastic force of the second elastic component 124′. Then, the user may release the positioning component 121 so that the positioning component 121 is reset by the elastic force of the sixth elastic component 123 as shown in FIG. 20C, and the clamping component 122′ and the carrying portion 1121′ are positioned at the first position. At this time, the user may place the electronic device 50 on the carrying structure 112A′ as shown in FIG. 20D, and then, as shown in FIG. 20E, the clamping component 122′ is pressed down along the second axial direction Z against the elastic force of the second elastic component 124′, so that the clamping component 122′ and the carrying portion 1121′ jointly clamp the electronic device 50. In this clamped state, since the positioning component 121 positions the clamping component 122′ and the carrying portion 1121′, the second elastic component 124′ may prevent the second elastic component 124′ from loosening the clamping component 122′ by its elastic force.

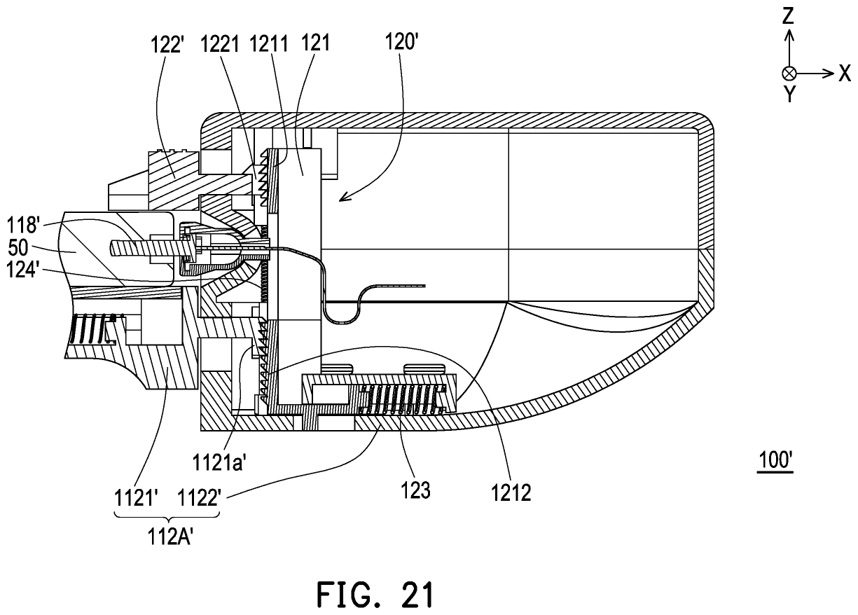

FIG. 21 shows that the electronic device of FIG. 20E is not equipped with a protective case. When the electronic device 50 is not equipped with the protective case 52 (shown in FIG. as shown in FIG. 21 and the dimensions in the first axial direction X and the second axial direction Z are reduced, the clamping portion 1122′ and the clamping component 122′ may smoothly clamp the electronic device 50 by adjusting the positions and states described above.

Referring to FIG. 20E, the positioning component 121 of this embodiment has first gear rack portions 1211 and 1212. The clamping component 122′ and the carrying portion 1121′ respectively have second gear rack portions 1221 and 1121a′, and the first gear rack portions 1211 and 1212 are respectively engaged with the second gear rack portions 1221 and 1121a′ to position the clamping component 122′ and the carrying portion 1121′.

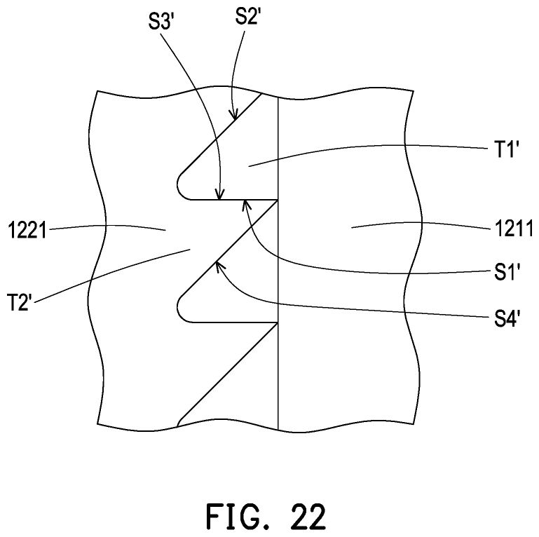

FIG. 22 is a partial enlarged view of the first gear rack portion and the second gear rack portion of FIG. 20E. Referring to FIG. 22, in more detail, each tooth T1′ of the first gear rack portion 1211 has a first blocking surface S1′ and a first guide inclined surface S2′ that are opposite to each other, and each tooth T2′ of the second gear rack portion 1221 has a second blocking surface S3′ and a second guide inclined surface S4′ that are opposite to each other. The first blocking surface S1′ and the second blocking surface S3′ face each other and prevent the clamping component 122′ from moving to the first position. The first guide inclined surface S2′ and the second guide inclined surface S4′ face each other. When the user applies a downward pressure on the clamping component 122′, the clamping component 122′ may be moved downward to a suitable position to clamp the electronic device 50 by being guided by of the first guide inclined surface S2′ and the second guide inclined surface S4′ and slightly elastically deforming the structure. The first gear rack portion 1212 and the second gear rack portion 1121a′ also have the same or similar designs and actuations, which are not repeated herein.

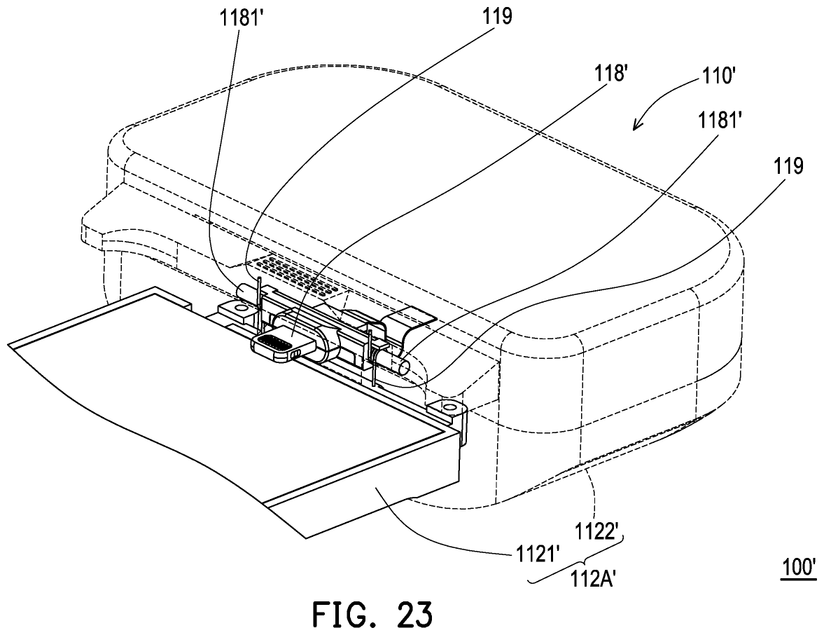

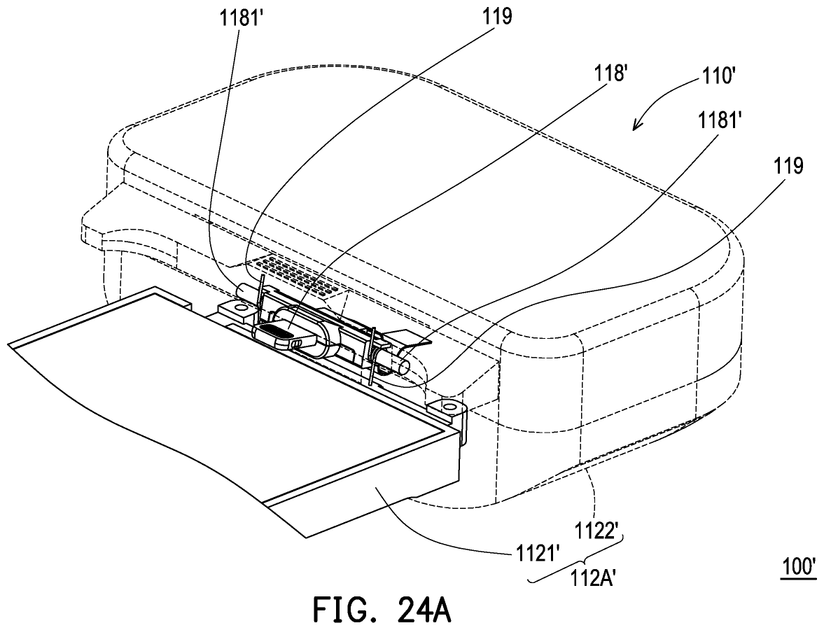

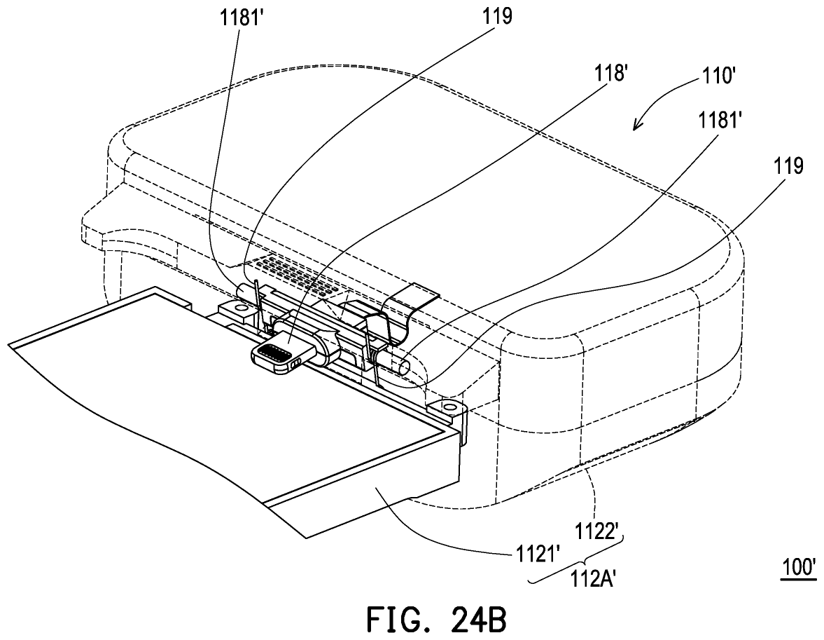

FIG. 23 is a partial structural three-dimensional view of the expansion device of FIG. 17. FIG. 24A and FIG. 24B show the inclination of the electrical connector of FIG. 23. Another main difference between the expansion device 100′ and the expansion device 100 is that the device body 110′ of the expansion device 100′ includes at least one torsion spring 119 (two are shown), and the torsion spring 119 is connected between the shaft portion 1181′ of the electrical connector 118′ and the corresponding clamping portion 1122′ of the carrying structure 112A′. The electrical connector 118′ may resist the elastic force of the torsion spring 119 to be inclined as shown in FIG. 24A or FIG. 24B, and may be reset by the elastic force of the torsion spring 119. In this embodiment, two torsion springs 119 are respectively disposed on opposite sides of the electrical connector 118′, so that the elastic forces provided by them are even and stable. In other embodiments, only one single torsion spring 119 may be disposed, which is not limited in the disclosure.

What is claimed is:

1. An expansion device, suitable for an electronic device and comprising:
a device body, comprising two carrying structures and a first elastic component, wherein the two carrying structures are slidably disposed on each other along a first axial direction, each of the carrying structures has a carrying portion and a clamping portion, the carrying portion is suitable for carrying the electronic device, the first elastic component is connected between the two carrying structures, the two carrying structures are suitable for relative sliding from a first state to a second state with variation of an elastic potential energy of the first elastic component, the two clamping portions are suitable for clamping the electronic device between the first state and the second state; and
at least one clamping structure, comprising a clamping component and a second elastic component, wherein the clamping component is movably disposed on one of the carrying structures along a second axial direction, the second elastic component is connected between the clamping component and the corresponding carrying structure, the clamping component is suitable for moving from a first position to a second position with variation of an elastic potential energy of the second elastic component, and is suitable for jointly clamping the electronic device with the carrying portion between the first position and the second position.

2. The expansion device according to claim 1, wherein a number of the at least one clamping structures is two, and the two clamping structures are respectively disposed on the two carrying structures.

3. The expansion device according to claim 1, wherein a distance between the two clamping portions in the second state is greater than a distance between the two clamping portions in the first state, the two carrying structures are suitable for relatively sliding from the first state to the second state by an elastic force of the first elastic component.

4. The expansion device according to claim 1, wherein the device body comprises a positioning assembly, the positioning assembly is movably disposed on one of the carrying structures, and is suitable for resisting an elastic force of the first elastic component to position another carrying structure between the first state and the second state.

5. The expansion device according to claim 4, wherein the positioning assembly comprises a push button, at least one positioning component, and a third elastic component, the push button is slidably disposed on the corresponding carrying structure, the third elastic component is connected to the at least one positioning component, the at least one positioning component is suitable for positioning the another carrying structure by an elastic force of the third elastic component, the push button is suitable for moving to drive the at least one positioning component to be separated from the another carrying structure.

6. The expansion device according to claim 5, wherein the positioning assembly comprises a fourth elastic component, the fourth elastic component is connected between the push button and the corresponding carrying structure, the push button is suitable for being reset by an elastic force of the fourth elastic component.

7. The expansion device according to claim 5, wherein the at least one positioning component has a first gear rack portion, the another carrying structure has a second gear rack portion, the first gear rack portion and the second gear rack portion are suitable for engaging with each other to position the another carrying structure.

8. The expansion device according to claim 7, wherein each tooth of the first gear rack portion has a first blocking surface and a first guide inclined surface that are opposite to each other, each tooth of the second gear rack portion has a second blocking surface and a second guide inclined surface that are opposite to each other, the first blocking surface and the second blocking surface face each other and prevent the another carrying structure from moving to the first state.

9. The expansion device according to claim 1, wherein a distance between the clamping component located at the first position and the carrying portion is greater than a distance between the clamping component located at the second position and the carrying portion, the clamping component is suitable for moving from the first position to the second position by an elastic force of the second elastic component.

10. The expansion device according to claim 1, wherein the clamping structure comprises at least one pushing assembly, the at least one pushing assembly is movably disposed on the corresponding carrying structure and is suitable for resisting an elastic force of the second elastic component to push the clamping component from the first position to the second position.

11. The expansion device according to claim 10, wherein the pushing assembly comprises two push rods, the two push rods are pivotally connected to each other and are suitable for relatively expanding to respectively push against the clamping component and the corresponding carrying portion, so that the clamping component and the corresponding carrying portion move away from each other along the second axial direction.

12. The expansion device according to claim 11, wherein the carrying structure has at least one guiding portion, the two push rods are respectively connected on opposite sides of the at least one guiding portion, the at least one pushing assembly is suitable for moving along a direction toward the at least one guiding portion, so that the two push rods are relatively expanded by being guided by the at least one guiding portion.

13. The expansion device according to claim 12, wherein the clamping structure comprises at least one fifth elastic component, the at least one fifth elastic component is connected between the at least one pushing assembly and the corresponding carrying structure, the at least one pushing assembly is suitable for being reset along a direction away from the at least one guiding portion by an elastic force of the at least one fifth elastic component.

14. The expansion device according to claim 1, wherein a distance between the two clamping portions in the second state is greater than a distance between the two clamping portions in the first state, the two carrying structures are suitable for relatively sliding from the second state to the first state by an elastic force of the first elastic component.

15. The expansion device according to claim 1, wherein the device body comprises a positioning assembly, the positioning assembly is movably disposed on one of the carrying structures, and is suitable for resisting an elastic force of the first elastic component to position another carrying structure in the second state.

16. The expansion device according to claim 15, wherein the positioning assembly comprises a push button, at least one positioning component, and a third elastic component, the push button is slidably disposed on the corresponding carrying structure, and the third elastic component is connected to the at least one positioning component, the at least one positioning component is suitable for positioning the another carrying structure by an elastic force of the third elastic component, the push button is suitable for moving to drive the at least one positioning component to release the another carrying structure.

17. The expansion device according to claim 16, wherein the positioning assembly comprises a fourth elastic component, the fourth elastic component is connected between the push button and the corresponding carrying structure, the push button is suitable for being reset by an elastic force of the fourth elastic component.

18. The expansion device according to claim 1, wherein a distance between the clamping component located at the first position and the carrying portion is greater than a distance between the clamping component located at the second position and the carrying portion, the clamping component is suitable for moving from the second position to the first position by an elastic force of the second elastic component.

19. The expansion device according to claim 1, wherein the clamping structure comprises a positioning component, the positioning component is disposed on the corresponding carrying structure and is suitable for resisting an elastic force of the second elastic component to position the clamping component between the first position and the second position.

20. The expansion device according to claim 19, wherein the positioning component has a first gear rack portion, the clamping component has a second gear rack portion, the first gear rack portion and the second gear rack portion are suitable for engaging with each other to position the clamping component.

21. The expansion device according to claim 20, wherein each tooth of the first gear rack portion has a first blocking surface and a first guide inclined surface that are opposite to each other, each tooth of the second gear rack portion has a second blocking surface and a second guide inclined surface that are opposite to each other, the first blocking surface and the second blocking surface face each other and prevent the clamping component from moving to the first position.

22. The expansion device according to claim 19, wherein the clamping structure comprises at least one sixth elastic component, the at least one sixth elastic component is connected between the positioning component and the corresponding carrying structure, the positioning component is suitable for positioning the clamping component by an elastic force of the at least one sixth elastic component.

23. The expansion device according to claim 1, wherein the device body comprises an electrical connector, and the electrical connector is disposed on one of the carrying structures and is suitable for being inserted into the electronic device along the first axial direction.

24. The expansion device according to claim 23, wherein the electrical connector is pivotally connected to the corresponding carrying structure along a rotation axis, the electrical connector is suitable for being rotated and inclined along the rotation axis.

25. The expansion device according to claim 24, wherein the electrical connector has a shaft portion, the corresponding carrying structure has a shaft hole, the shaft portion is pivotally connected to the shaft hole along the rotation axis, a friction force between the shaft hole and the shaft portion is suitable for fixing an inclination angle of the electrical connector.

26. The expansion device according to claim 24, wherein the shaft portion has a convex point, an inner wall of the shaft hole has a concave point, the convex point is suitable for being positioned on the concave point.

27. The expansion device according to claim 24, wherein the electrical connector has a shaft portion and is pivotally connected to the corresponding carrying structure by the shaft portion, the device body comprises a torsion spring, the torsion spring is connected between the shaft portion and the corresponding carrying structure, the electrical connector is suitable for being inclined by resisting an elastic force of the torsion spring and is suitable for being reset by the elastic force of the torsion spring.
